(19) United States
(12) Patent Application Publication
(10) Pub. No.: US 2022/0077590 A1
(43) Pub. Date: Mar. 10, 2022

(54) FREQUENCY SELECTIVE SURFACE

(71) Applicant: Nippon Telegraph and Telephone Corporation, Tokyo (JP)

(72) Inventors: Go Itami, Tokyo (JP); Yohei Toriumi, Tokyo (JP); Jun KATO, Tokyo (JP)

(21) Appl. No.: 17/414,475

(22) PCT Filed: Dec. 11, 2019
(86) PCT No.: PCT/JP2019/048427

§ 371 Date: Jun. 16, 2021

(30) Foreign Application Priority Data
Dec. 25, 2018 (JP) 2018-240590

(51) Int. Cl. H01Q 15/14

(52) U.S. Cl. CPC H01Q 15/14

(57) ABSTRACT

To provide a frequency selective surface of which an operating frequency and a bandwidth thereof can be readily adjusted. A frequency selective surface structured such that resonators k_{xy} formed by conductive patterns with a same shape are periodically arranged on a dielectric substrate, wherein the resonator k_{xy} includes: a conductor wire part with a lateral pattern 10 and a longitudinal pattern 20 which form a cross above a dielectric substrate 101; and an electrode plate part created by extending, in directions in which the lateral pattern and the longitudinal pattern are orthogonal to each other, respective both end parts of the lateral pattern and the longitudinal pattern having been extended by a prescribed length, the electrode plate part being shaped such that a tip portion thereof opposes a tip portion extended from another direction at an interval above a diagonal line, and the electrode plate part is shaped such that a central portion opposing an electrode plate part of another adjacent resonator is notched in a width of the lateral pattern, the electrode plate part being joined with the electrode plate part of the other adjacent resonator by being extended from a center of the notched portion in a width that is narrower than the width of the lateral pattern 10 and in a length that is shorter than the prescribed length, and the interval of the tip portion is wider than an interval with the electrode plate part of the other adjacent resonator.

### TECHNICAL FIELD

The present invention relates to a frequency selective surface with a structure in which resonators of a same shape are periodically arranged on a dielectric substrate.

### BACKGROUND ART

Reduced sizes and increased functionality of information communication devices have led to a rapid proliferation of wireless communication services that use lines such as a wireless LAN and LTE. Accordingly, transmission and reception of radio waves by wireless communication terminals are being performed more frequently over a wider area, which is a concern in terms of effects of the radio waves on other electronic devices in the periphery.

Conceivable effects of concern include degradation of a wireless environment, communication failure, and threat to security. A technique for suppressing such effects is required.

Frequency selective surfaces (FSS) can be used for the purpose of controlling a radio wave environment and an electromagnetic environment. Frequency selective surfaces impart frequency dependency to transmission characteristics/reflection characteristics of incident electromagnetic waves by periodically arranging resonators (unit cells) formed by conductor patterns of which dimensions are approximately equal to or smaller than a wavelength.

Frequency selective surfaces include resonance structures with various frequency characteristics. For example, most of frequency selective surfaces having band-stop filter characteristics which only reflect specific frequencies are configured such that a conductor part has a resonance structure, and examples thereof include a ring type, a dipole array type, a tri-hole type, a patch type, and a Jerusalem cross type (NPL 1).

Frequency selective surfaces have a large number of structural parameters to be taken into consideration and, some cases, parameters have a conflicting relationship with increases and decreases in an inductance component and a capacitance component. In addition, characteristics also change depending on how the unit cells are arranged, which all combine to make the underlying theory complicated (NPL 2).

### CITATION LIST

### Non Patent Literature

[NPL 1] Shigeru Makino, “[Tutorial lecture] Basic Design Theory of Frequency Selective Reflector and its Applications”, Shingakugiho, A P 2015-5, Apl. 2015
[NPL 2] BEN A. MUNK, “Frequency Selective Surfaces Theory and Design”, 2000.

### SUMMARY OF THE INVENTION

### Technical Problem

Since the theory is complicated, it is difficult to obtain desired frequency characteristics in one attempt. Therefore, designing frequency selective surfaces has a problem of being cost and labor intensive.

The present invention has been made in consideration of the problem described above and an object thereof is to provide a frequency selective surface of which an operating frequency and a bandwidth can be readily adjusted.

### Means for Solving the Problem

A frequency selective surface according to an aspect of the present invention is a frequency selective surface structured such that resonators formed by conductive patterns with a same shape are periodically arranged on a dielectric substrate, wherein the resonator includes: a conductor wire part with a lateral pattern and a longitudinal pattern which form a cross above the dielectric substrate; and an electrode plate part created by extending, in directions in which the lateral pattern and the longitudinal pattern are orthogonal to each other, respective both end parts of the lateral pattern and the longitudinal pattern having been extended by a prescribed length, the electrode plate part being shaped such that an extended tip portion opposes a tip portion extended from another direction at an interval above a diagonal line, wherein the electrode plate part is shaped such that a central portion opposing an electrode plate part of another adjacent resonator is notched in a width of the lateral pattern, the electrode plate part being joined with the electrode plate part of the other adjacent resonator by being extended from a center of the notched portion in a width that is narrower than the width of the lateral pattern and in a length that is shorter than the prescribed length, and the interval of the tip portion is wider than an interval with the electrode plate part of the other adjacent resonator.

### Effects of the Invention

According to the present invention, a frequency selective surface of which an operating frequency and a bandwidth thereof can be readily adjusted can be provided.

### BRIEF DESCRIPTION OF DRAWINGS

FIG. 1 is a diagram showing a partial plane of a frequency selective surface according to a first embodiment of the present invention.

FIG. 2 is a diagram schematically showing a path along which a current corresponding to a plurality of resonance frequencies included in the frequency selective surface shown in FIG. 1 flows.

FIG. 3 is a diagram showing approximate positions and equivalent circuits of an induction component and a capacity component of the frequency selective surface shown in FIG. 1.

FIG. 4 is a diagram showing an example of parameters of a shape of the frequency selective surface shown in FIG. 1.

FIG. 5 is a diagram showing an example of frequency characteristics of the frequency selective surface shown in FIG. 1.

FIG. 6 is a diagram showing an example of a change in cutoff frequency due to a capacity component.

FIG. 7 is a diagram showing a partial plane of a frequency selective surface according to a second embodiment of the present invention.

FIG. 8 is a diagram showing a capacity component that forms a sub-resonator of the frequency selective surface shown in FIG. 7.

FIG. 9 is a diagram showing an equivalent circuit of the frequency selective surface shown in FIG. 7.

FIG. 10 is a diagram showing a change in cutoff frequency when changing a shape of a conductive pattern of the sub-resonator shown in FIG. 7.

FIG. 11 is a diagram showing a partial plane of a frequency selective surface according to a third embodiment of the present invention.

FIG. 12 shows an equivalent circuit in which a capacity component is connected in parallel to an equivalent circuit of a low frequency-side bandpass resonator.

FIG. 13 is a diagram showing an example of reflection characteristics in a case of changing shapes of second conductive patterns that respectively constitute a sub-resonator corresponding to a low frequency-side bandpass resonator and a sub-resonator corresponding to a high frequency-side bandpass resonator.

### DESCRIPTION OF EMBODIMENTS

Hereinafter, embodiments of the present invention will be described with reference to the drawings. Same elements in a plurality of drawings will be denoted by same reference signs and descriptions will not be repeated.

### First Embodiment

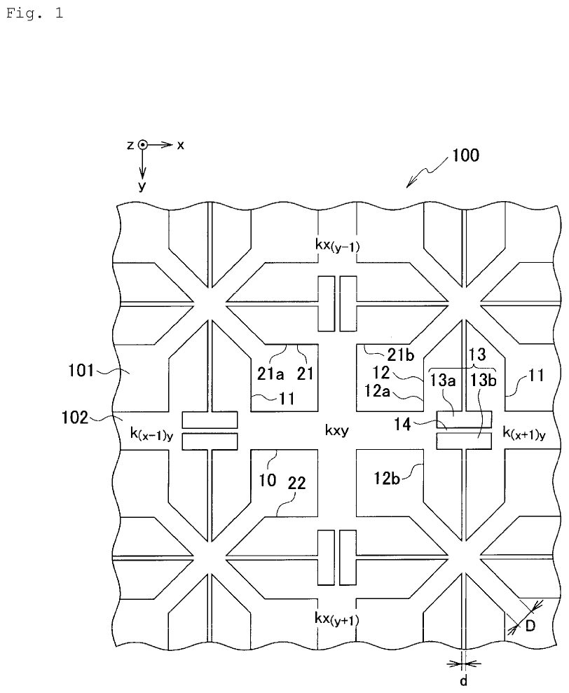

FIG. 1 is a diagram schematically showing a partial plane of a frequency selective surface according to a first embodiment of the present invention. A frequency selective surface 100 shown in FIG. 1 is configured by periodically arranging resonators k_{xy} formed by a conductive pattern with a shape similar to a two-by-two matrix on a dielectric substrate 101. In FIG. 1, an x direction will be defined as being lateral and a y direction as being longitudinal.

For example, the dielectric substrate 101 is constituted of a glass epoxy board, a polyimide film board, or the like. The dielectric substrate 101 may be made of any material as long as the material is a dielectric material.

A conductive film 102 is formed on the dielectric substrate 101. The resonator k_{xy} (the conductive pattern) having a prescribed shape may be formed on the dielectric substrate 101 by vapor deposition or the conductive film 102 may be formed over an entire surface of the dielectric substrate 101 and subsequently etched to form the resonator k_{xy}.

For example, 10 resonators k_{xy} are respectively arranged in the x direction and the y direction to construct the frequency selective surface 100. A size of a single resonator k_{xy} is around ⅓ of a wavelength of a resonance frequency.

A signal is input to the frequency selective surface 100 from a −z direction (a rear side) and output (transmitted) in a z direction (a front side). When an electromagnetic wave is input to the frequency selective surface 100, an electric field is created on an xy plane on which the resonator k_{xy} is arranged and a current flows due to a resonance phenomenon.

A configuration of the resonator k_{xy} will now be described on the basis of its relationship with a resonator k_{(x+1)y} that is adjacent in a +x direction.

The resonator k_{xy} includes a conductor wire part having a lateral pattern 10 and a longitudinal pattern 20 which form a cross above the dielectric substrate 101. Furthermore, respective both end parts in which the lateral pattern 10 and the longitudinal pattern 20 have been extended by a prescribed length are respectively extended (12a, 12b) in orthogonal directions. In addition, the resonator k_{xy} includes an electrode plate part 12 that is shaped such that a tip portion thereof opposes a tip portion having been extended from another direction across an interval D on a diagonal line.

In addition, a central portion of the electrode plate part 12 which opposes an electrode plate part 11 of another adjacent resonator k_{(x+1)y} is notched in a width of the lateral pattern 10 (a notched part 13). Furthermore, the electrode plate part 12 is extended from a center of the notched part 13 in a width that is narrower than the width of the lateral pattern 10 and in a length that is shorter than a length of the lateral pattern 10 to be joined with the electrode plate part 11 of the other adjacent resonator k_{(x+1)y} (a conductor pattern 14). The interval D between tip portions of the conductor patterns 12a and 12b respectively extended in directions that are orthogonal to the lateral pattern 10 is a wider shape than an interval d with the electrode plate part 11 of the other adjacent resonator k_{(x+1)y}. In other words, a planar shape of the electrode plate part 12 is a trapezoid of which an outer side is a lower base and an inner side is an upper base, and a central portion of the lower base is notched. Furthermore, the electrode plate part 12 is shaped such that the conductor pattern 14 with a width that is narrower than the lateral pattern 10 is extended from a center of the notched part 13 in the y direction to be joined with the electrode plate part 11 of the other adjacent resonator k_{(x+1)y}. The notched part 13 is divided into two parts, namely, notched parts 13a and 13b, by the conductor pattern 14.

While the configuration of the resonator k_{xy} has been described above on the basis of its relationship with the resonator k_{(x+1)y} that is adjacent in the +x direction, the configuration is the same in a vertical direction (y) and a horizontal direction (x). In other words, each resonator k_{xy} is vertically symmetrical about a central line of the lateral pattern 10. In addition, each resonator k_{xy} is horizontally symmetrical about a central line of the longitudinal pattern 20.

According to the characteristic configuration of the resonator k_{xy}, the frequency selective surface 100 according to the present embodiment includes a resonance path along which three resonance currents flow.

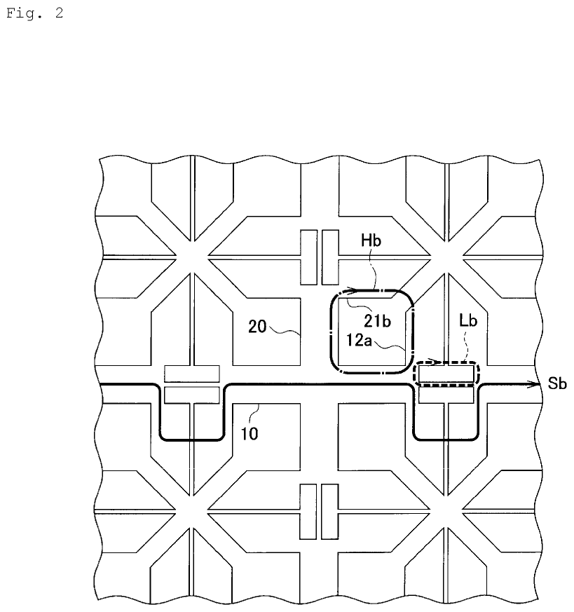

FIG. 2 is a diagram schematically showing a resonance path along which flow three resonance currents that flow through the frequency selective surface 100. The three resonance currents are: a stop band path Sb along which a resonance current of a cutoff frequency (operating frequency f_{Sb}) that is a series resonance frequency flows; a low frequency-side bandpass path Lb along which a resonance current of a low frequency-side parallel resonance frequency (a low frequency-side bandpass frequency f_{Lb}) flows; and a high frequency-side bandpass path Hb along which a resonance current of a high frequency-side parallel resonance frequency (a high frequency-side bandpass frequency f_{Hb}) flows.

The low frequency-side bandpass path Lb constitutes a low frequency-side bandpass resonator k_{Lb}. The high frequency-side bandpass path Hb constitutes a high frequency-side bandpass resonator k_{Hb}.

The stop band path Sb is a path that passes through lateral patterns 10 and longitudinal patterns 20 of adjacent resonators k_{xy}. In FIG. 2, only a path on a +y side of the x direction is shown in order to prevent the drawing from becoming complicated. The actual stop band path Sb symmetrically exists in the −y direction centered on the lateral pattern 10. In addition, the actual stop band path Sb also exists in ±x directions centered on the longitudinal pattern 20.

The low frequency-side bandpass path Lb is a path that circles around notched parts 13a of adjacent resonators k_{xy}. In FIG. 2, only a path on a +y side of the x direction is shown in a similar manner to the stop band path Sb. The actual low frequency-side bandpass path Lb symmetrically exists in the −y direction centered on the lateral pattern 10. In addition, the low frequency-side bandpass path Lb also exists in the ±x directions centered on the longitudinal pattern 20.

The high frequency-side bandpass path Hb is a path that circles around electrode plate parts 12a and 21b that cause tip portions of a single resonator k_{xy} to oppose each other. Due to its vertically and horizontally symmetrical configuration, four high frequency-side bandpass paths Hb exist in a single resonator k_{xy}. In FIG. 2, only a path that circles around the electrode plate parts 12a and 21b is shown.

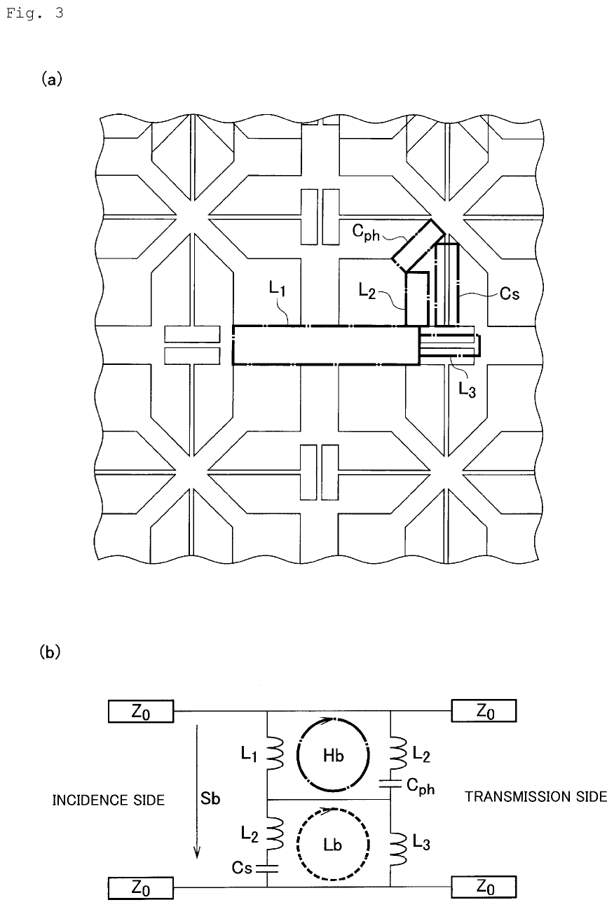

FIG. 3 is a diagram that schematically shows portions on the resonator k_{xy} of an induction component and a capacity component which constitute each resonance path. The induction component is denoted by L and the capacity component is denoted by C.

FIG. 3(a) is a diagram in which approximate shapes of portions that constitute each component are enclosed by dashed lines. FIG. 3(b) is a diagram which shows each resonance path using an equivalent circuit.

The stop band path Sb can be expressed as a series connection of an induction component L1 that is formed by the lateral pattern 10 and the longitudinal pattern 20, an induction component L2 that is formed by the electrode plate part 12a in a direction orthogonal to the lateral pattern 10, and a capacity component Cₛ that is formed between the electrode plate part 12a and the electrode plate part 11 of the adjacent resonator k_{(x+1)y} (a path depicted by an arrow in FIG. 3(b)).

The low frequency-side bandpass path Lb can be expressed as a path created by connecting, in parallel, an induction component L3 that is formed by the conductor pattern 14 connecting the x direction of the notched part 13 to a series connection of the induction component L2 and the capacity component Cₛ (a path depicted by a dashed-line circle in FIG. 3(b)).

The high frequency-side bandpass path Hb can be expressed as a path created by connecting, in parallel, a series connection of a capacity component Cₚₕ formed by tip portions of the conductor patterns 12a and 21b and the induction component L2 to the capacity component L1 (a path depicted by a dashed-dotted-line circle in FIG. 3(b)).

Z₀ shown in FIG. 3(b) represents space impedance. The space impedance Z₀ is an impedance that is determined by permittivity and permeability of vacuum.

A resonance frequency that is created on each path can be determined by parameters that represent a shape of the resonator k_{xy}. The parameters are, mainly, dimensions of respective parts that determine the shape of the resonator k_{xy}.

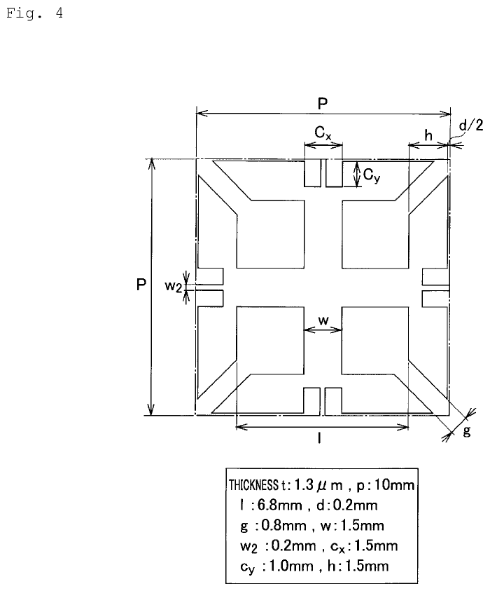

FIG. 4 is a diagram showing an example of the parameters that determine the shape of the resonator k_{xy}. A thickness of the conductive pattern is 1.3 μm. A pitch at which the resonator k_{xy} is periodically arranged is set to 10 mm.

A length of the lateral pattern 10 and the longitudinal pattern 20 is denoted by l, a width of the lateral pattern 10 and the longitudinal pattern 20 is denoted by w, a length of the electrode plate part 12 in the x direction is denoted by h (a height of the trapezoidal shape), a width of the notched part is denoted by cₓ, a depth of the notched part is denoted by c_{y}, a width of the conductive pattern 14 that bridges inside the notched part 13 is denoted by w₂, and a width of the interval D between tip portions of the electrode plate part is denoted by g.

Once these dimensions are determined, the shape of the resonator k_{xy} including the length of the conductive pattern 14 is determined. In addition, by determining the shape of the resonator k_{xy}, values of the induction components L1 and L2 and the capacity components Cₛ and Cₚₕ described above are determined.

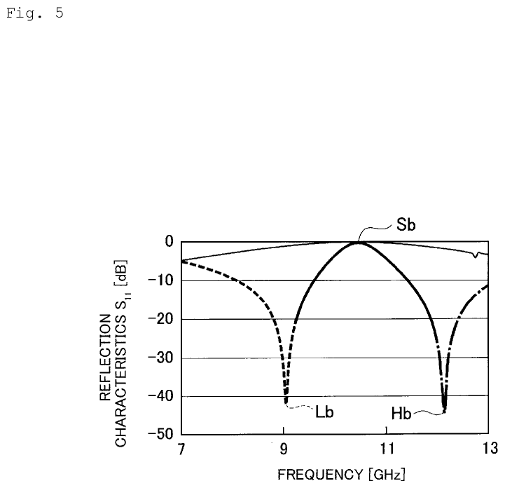

FIG. 5 shows an analysis result of a resonance frequency of the frequency selective surface shown in FIG. 4. An abscissa in FIG. 5 indicates frequency [GHz] and an ordinate in FIG. 5 indicates a reflection coefficient S₁₁ [dB] that represents reflection characteristics. Parameters of the analyzed resonator k_{xy} are: l=6.8 mm, d=0.2 mm, g=0.8 mm, w=1.5 mm, w₂=0.2 mm, cₓ=1.5 mm, c_{y}=1.0 mm, and h=1.5 mm.

As shown in FIG. 5, three resonance frequencies centered on the cutoff frequency f_{Sb} and including the low frequency-side transmission frequency f_{Lb} and the high frequency-side transmission frequency f_{Hb} are obtained. Each resonance frequency is determined by respectively corresponding parameters.

The cutoff frequency f_{Sb} is determined by the induction component L1 that is formed by the lateral pattern 10 and the longitudinal pattern 20, the induction component L2 that is formed by the electrode plate part 12a in a direction orthogonal to the lateral pattern 10, and the capacity component Cₛ that is formed between the electrode plate part 12a and an electrode plate part 11a of the adjacent resonator k_{(x+1)y}. Therefore, among the parameters, the cutoff frequency f_{Sb} is determined by the length l of the lateral pattern 10 and the longitudinal pattern 20, the width w of the lateral pattern 10 and the longitudinal pattern 20, the pitch p, and the interval d from the electrode plate part of another adjacent resonator.

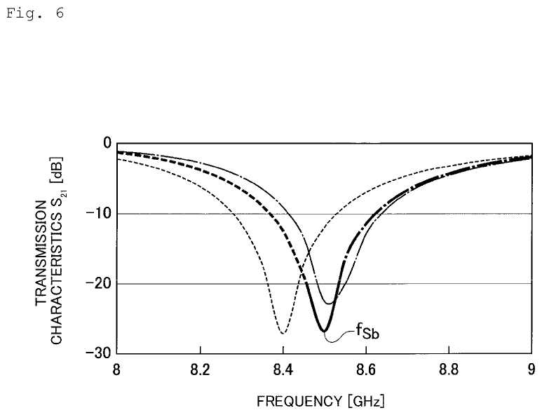

FIG. 6 is a diagram showing an example of a change in the cutoff frequency f_{Sb} due to the capacity component Cₛ. An abscissa in FIG. 6 indicates frequency [GHz] and an ordinate in FIG. 6 indicates a transmission coefficient S₂₁ [dB] that represents transmission characteristics. A dashed line represents a case where the capacity component Cₛ is increased and a dashed-dotted line represents a case where the capacity component Cₛ is reduced. In this manner, the cutoff frequency f_{Sb} can be changed according to the capacity component Cₛ.

The low frequency-side transmission frequency f_{Lb} is determined by the induction component L3 due to the width w₂ of the conductive pattern 14 that bridges inside the notched part 13 and the pitch p, the induction component L2, and the capacity component Cₛ. The induction component L2 and the capacity component Cₛ are also parameters that determine the cutoff frequency f_{Sb}. Therefore, the low frequency-side transmission frequency f_{Lb} can be mainly controlled by the width w₂ of the conductive pattern 14.

The high frequency-side transmission frequency f_{Hb} is determined by the capacity component Cₚₕ that is formed by tip portions of the conductor patterns 12a and 21b and the induction component L2. The induction component L2 is also the parameter that determines the cutoff frequency f_{Sb}. Therefore, the high frequency-side transmission frequency f_{Hb} can be mainly controlled by the capacity component Cₚₕ that is formed by tip portions of the conductor patterns 12a and 21b.

As described above, each of the three resonance frequencies of a resonator can be controlled independently. In other words, an operating frequency and a bandwidth thereof can be readily adjusted.

As described above, the frequency selective surface 100 according to the present embodiment has a structure in which the resonators k_{xy} formed by conductive patterns of a same shape are periodically arranged on the dielectric substrate 101. In the frequency selective surface 100, the resonator k_{xy} includes a conductor wire part having a lateral pattern 10 and a longitudinal pattern 20 which form a cross above the dielectric substrate 101. Furthermore, in the frequency selective surface 100, respective both end parts in which the lateral pattern 10 and the longitudinal pattern 20 have been extended by a prescribed length are respectively extended in orthogonal directions. In addition, the resonator k_{xy} includes the electrode plate part 12 that is shaped such that a tip portion thereof opposes a tip portion having been extended from another direction across an interval on a diagonal line. Furthermore, in the frequency selective surface 100, a central portion of the electrode plate part 12 which opposes the electrode plate part 11 of another adjacent resonator is notched in a width of the lateral pattern 10. In addition, the electrode plate part 12 is extended from a center of the notched portion 13 in a width that is narrower than the width of the lateral pattern 10 and in a length that is shorter than the prescribed length to be joined with the electrode plate part 11 of the other adjacent resonator. Furthermore, an interval D between tip portions of the electrode plate part is a wider shape than an interval d with the electrode plate part 11 of the other adjacent resonator. Accordingly, an operating frequency and a bandwidth thereof can be readily adjusted.

Since the frequency selective surface 100 according to the present embodiment includes the low frequency-side transmission frequency f_{Lb} and the high frequency-side transmission frequency f_{Hb} in addition to the central cutoff frequency f_{Sb}, bandwidths of cutoff characteristics (band-stop characteristics) can be made narrower by bringing the low frequency-side transmission frequency f_{Lb} and the high frequency-side transmission frequency f_{Hb} closer to the cutoff frequency f_{Sb}.

### Second Embodiment

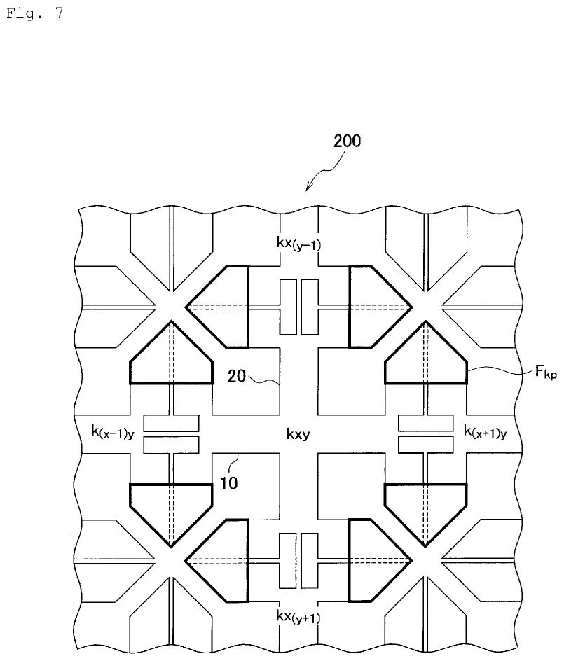

FIG. 7 is a diagram schematically showing a plan view of a frequency selective surface according to a second embodiment of the present invention. A frequency selective surface 200 shown in FIG. 6 differs from the frequency selective surface 100 (FIG. 1) in including a sub-resonator.

The sub-resonator of the frequency selective surface 200 shown in FIG. 7 is constituted of a second conductive pattern Fₖₚ with, for example, a home base shape which covers tip portions of adjacent electrode plate parts 12a and 11a. The second conductive pattern Fₖₚ is also formed in tip portions of electrode plate parts 21 and 22 in the y direction.

The second conductive pattern Fₖₚ is formed by superposition while sandwiching the conductive film 102 of the electrode plate part 12a and the like and a dielectric layer. For example, conceivable methods of superimposing the conductive pattern Fₖₚ in layers include a method of superimposing and mounting two flexible boards or rigid boards on which the resonator k_{xy} and the conductive pattern Fₖₚ are formed and a method of fixing two conductive patterns having been printed on a PET board in a state where conductive patterns are superimposed by lamination. Alternatively, the second conductive pattern Fₖₚ may be fabricated using a semiconductor process that forms a vapor-deposited film and a diffusion film.

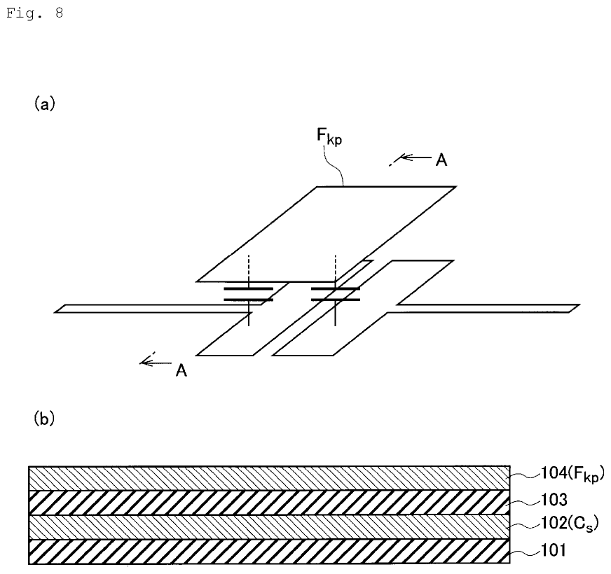

FIG. 8 is a diagram schematically showing a structure of the sub-resonator. FIG. 7(a) is a perspective view thereof. FIG. 8(b) is a sectional view cut along line A-A shown in FIG. 8(a).

As shown in FIG. 8(a), a series connection of two capacity components Cₛ′ is connected in parallel to the capacity component Cₛ that is formed by adjacent electrode plate parts 12a and 11a by the conductive pattern Fₖₚ created by superposition by sandwiching a dielectric layer between the adjacent electrode plate parts 12a and 11a.

As shown in FIG. 8(b), the capacity component Cₛ′ is constituted of four layers, namely, the dielectric substrate 101, the conductive film 102, a dielectric film 103 and a second conductive pattern 104. Dielectric films and conductive films may be further increased. Details will be provided later.

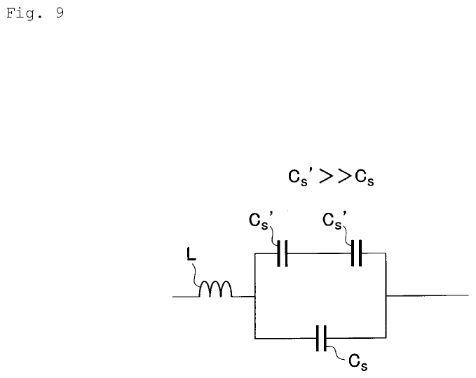

FIG. 9 is a diagram schematically showing an equivalent circuit of the frequency selective surface 200 including a sub-resonator. An equivalent circuit of the resonator k_{xy} (hereinafter, sometimes referred to as a main resonator) that is formed by the conductive film 102 is expressed as a series connection of an induction component L and the capacity component Cₛ.

Therefore, the frequency selective surface 200 can be expressed as an equivalent circuit in which a series connection of two capacity components Cₛ′ is connected in parallel to the capacity component Cₛ of the main resonator k_{xy}. A capacity formed between the second conductive pattern Fₖₚ and the electrode plate parts 12a and 11a is larger than the capacity component Cₛ that is formed between the electrode plate parts 12a and 11a (Cₛ′>>Cₛ).

As is apparent from the equivalent circuit shown in FIG. 9, a cutoff frequency of the frequency selective surface 200 according to the present embodiment is a frequency to which the capacity component Cₛ′ has been added. Therefore, the cutoff frequency can be controlled by changing a shape of the second conductive pattern that forms the sub-resonator while keeping a shape of the main resonator k_{xy} the same.

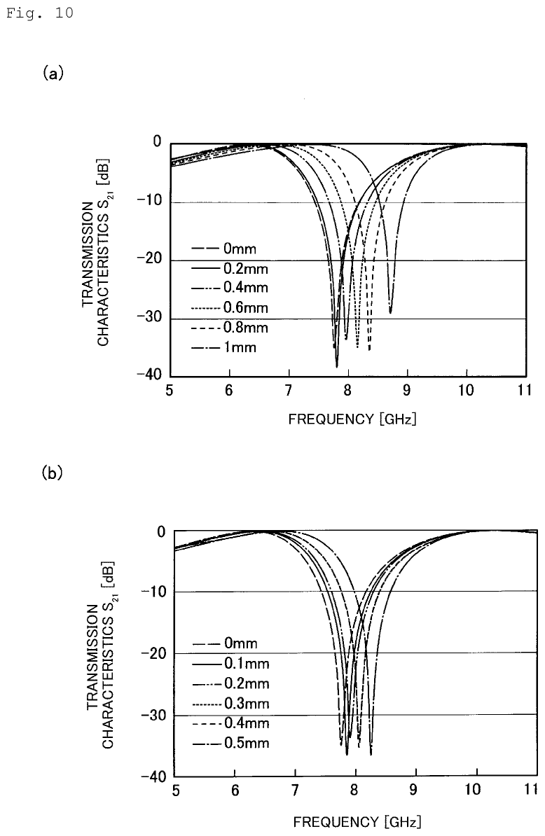

FIG. 10 is a diagram showing a change in cutoff frequency when changing a shape of the second conductive pattern Fₖₚ.

FIG. 10(a) is a diagram showing a change when changing a length in the x direction and FIG. 10(b) is a diagram showing a change when changing a length in the y direction. An abscissa in FIG. 10 indicates frequency [GHz] and an ordinate in FIG. 10 indicates the transmission coefficient S₂₁ [dB] that represents transmission characteristics.

A parameter 0 mm in FIG. 10(a) represents a case of a shape of the second conductive pattern Fₖₚ shown in FIG. 6. A parameter 0.2 mm represents a change of −0.2 mm to the width of the second conductive pattern Fₖₚ. Specifically, the characteristics represent a change of −0.1 mm from an outer side of one electrode plate part 12a and a change of −0.1 mm from an outer side of the other electrode plate part 11a.

As shown in FIG. 10(a), by changing the width of the second conductive pattern Fₖₚ within a range of 0 to 1 mm, the cutoff frequency can be made variable within a range of approximately 1 GHz. In other words, the cutoff frequency can be adjusted by changing the shape of the second conductive pattern Fₖₚ without changing the shape of the main resonator k_{xy}.

Parameters 0 mm to 0.5 mm in FIG. 10(b) represent dimensions by which the length of the second conductive pattern Fₖₚ in the y direction has been changed. The parameter 0 mm represents a case of the shape of the second conductive pattern Fₖₚ shown in FIG. 6.

As shown in FIG. 10(b), by changing the length of the second conductive pattern Fₖₚ in the y direction within a range of 0 to 0.5 mm, the cutoff frequency can be made variable within a range of approximately 0.5 GHz. In this manner, the cutoff frequency can also be adjusted by changing the length of the second conductive pattern Fₖₚ in the y direction.

As described above, the frequency selective surface 200 according to the present embodiment includes a second conductive pattern that is arranged on a conductor wire part so as to sandwich a dielectric film, and a planar shape of the second conductive pattern is a shape by which adjacent resonators cover a same portion and a shape which covers a space between electrode plate parts of a same resonator. Accordingly, the cutoff frequency of the main resonator k_{xy} can be adjusted without changing the shape of the main resonator k_{xy}.

### Third Embodiment

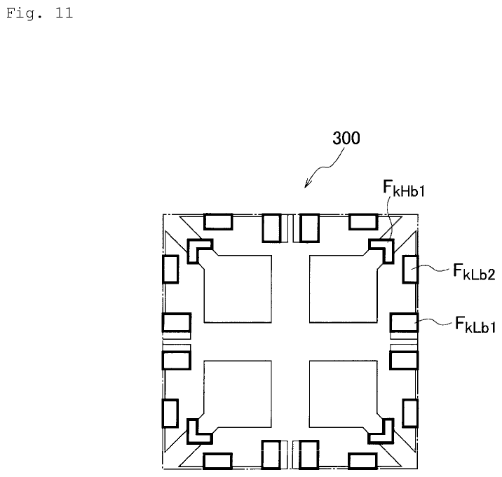

FIG. 11 is a diagram schematically showing a plan view of a frequency selective surface according to a third embodiment of the present invention. A frequency selective surface 300 shown in FIG. 11 includes sub-resonators respectively corresponding to the low frequency-side bandpass resonator k_{Lb} and the high frequency-side bandpass resonator k_{Hb} with respect to the frequency selective surface 100 (FIG. 1).

In this example, the sub-resonator corresponding to the low frequency-side bandpass resonator k_{Lb} is constituted of two second conductive patterns F_{kLb1} and F_{kLb2}. The second conductive patterns F_{kLb1} and F_{kLb2} are formed by superposition while sandwiching the conductive film 102 of the electrode plate part 12a and the like and a dielectric layer in a similar manner to the second conductive pattern Fₖₚ.

Each of the second conductive patterns F_{kLb1} and F_{kLb2} forms capacity components Cₛ₁′ and Cₛ₂′. The second conductive patterns F_{kLb1} and F_{kLb2} have a same shape that straddles adjacent resonators. In other words, respective shapes of the second conductive pattern F_{kLb1} on the electrode plate 12a and on the electrode plate 11a are the same and are connected between adjacent resonators. The capacity components Cₛ₁′ and Cₛ₂′ operate by being connected in parallel to a parallel resonance frequency of the low frequency-side bandpass resonator k_{Lb}.

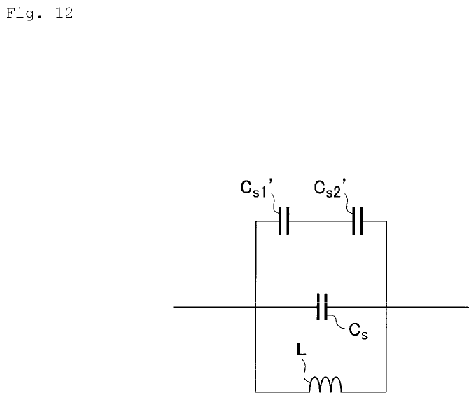

FIG. 12 shows an equivalent circuit in which the capacity components Cₛ₁′ and Cₛ₂′ are connected in parallel to an equivalent circuit of the low frequency-side bandpass resonator k_{Lb}. As is apparent from the equivalent circuit, the low frequency-side transmission frequency f_{Lb} of the frequency selective surface 300 according to the present embodiment is a frequency to which the capacity components Cₛ₁′ and Cₛ₂′ have been added. Therefore, the low frequency-side transmission frequency f_{Lb} can be controlled by changing a shape of the second conductive pattern that forms the sub-resonator while keeping a shape of the low frequency-side bandpass resonator k_{Lb} the same.

The second conductive pattern F_{kHb1} forms the capacity component Cₛ₁′ to be connected in parallel to an equivalent circuit of the high frequency-side bandpass resonator k_{Hb}. The high frequency-side transmission frequency f_{Hb} can be controlled by the second conductive pattern F_{kHb1}. An effect thereof is the same as in the case of the low frequency-side transmission frequency f_{Lb}.

The low frequency-side bandpass resonator k_{Lb} and the high frequency-side bandpass resonator k_{Hb} can be respectively controlled independently. Therefore, a bandwidth of the cutoff frequency can be controlled by changing a shape of the second conductive patterns F_{kLb1} and F_{kLb2} that correspond to the low frequency-side bandpass resonator k_{Lb} and a shape of the second conductive pattern F_{kHb1} that corresponds to the high frequency-side bandpass resonator k_{Hb}.

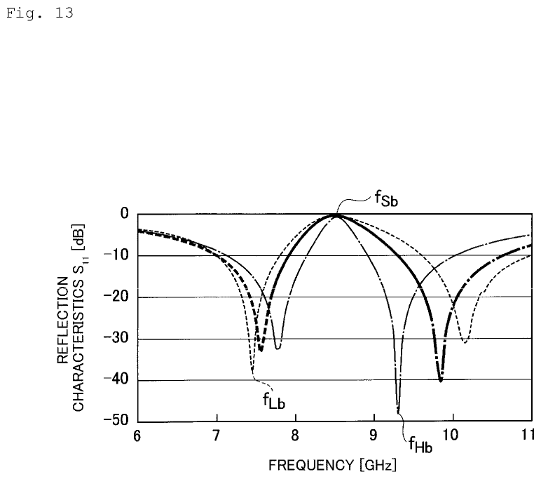

FIG. 13 is a diagram showing an example of reflection characteristics in a case of changing shapes of second conductive patterns F_{kLb1}, F_{kLb2}, and F_{kHb1} that respectively constitute a sub-resonator corresponding to the low frequency-side bandpass resonator k_{Lb} and a sub-resonator corresponding to the high frequency-side bandpass resonator k_{Hb} while keeping a shape of the main resonator k_{xy} fixed.

An abscissa in FIG. 13 indicates frequency [GHz] and an ordinate in FIG. 13 indicates the reflection coefficient S₁₁ [dB] that represents reflection characteristics.

In FIG. 13, a dashed line depicts an example of characteristics when lowering the low frequency-side transmission frequency f_{Lb} and raising the high frequency-side transmission frequency f_{Hb}. A dashed-dotted line depicts an example of characteristics when raising the low frequency-side transmission frequency f_{Lb} and lowering the high frequency-side transmission frequency f_{Hb}. In this manner, the bandwidth of the frequency selective surface 300 can be controlled by changing shapes of the second conductive patterns F_{kLb1}, F_{kLb2}, and F_{kHb1} that constitute sub-resonators that respectively correspond to the low frequency-side bandpass resonator k_{Lb} and the high frequency-side bandpass resonator k_{Hb}.

It should be noted that the cutoff frequency has not changed significantly. In the example shown in FIG. 13, a change to the cutoff frequency is 3% or less. In this manner, the bandwidth can be made variable without changing the cutoff frequency.

While the second conductive patterns F_{kLb1} and F_{kLb2} and the second conductive pattern F_{kHb1} have been described using an example in which all of the second conductive patterns are provided in a second conductive pattern, the second conductive patterns F_{kLb1} and F_{kLb2} and the second conductive pattern F_{kHb1} may be provided in conductive patterns of different layers. For example, the second conductive pattern F_{kHb1} may be formed by a third conductive pattern (not illustrated) that is arranged on the second conductive pattern F_{kLb1} or the like so as to sandwich a dielectric film.

In addition, a third conductive pattern (not illustrated) with a same shape may be formed so as overlap with the second conductive patterns F_{kLb1} and F_{kLb2}. The third conductive pattern with a same shape further enables a capacity component to be added in parallel to a parallel resonance circuit.

In addition, the second conductive pattern F_{kHb1} having a hook shape in FIG. 11 may be formed by a third conductive pattern (not illustrated). Accordingly, a sub-resonator that acts on the high frequency-side bandpass resonator k_{Hb} can be added.

As described above, the frequency selective surface 300 according to the third embodiment of the present invention includes a third conductive pattern that is arranged on a second conductive pattern so as to sandwich a dielectric film, and a planar shape of the third conductive pattern is a same shape as the second conductive pattern or a different shape from the second conductive pattern. Accordingly, a degree of freedom of design of the frequency selective surface 300 can be improved. In addition, since a larger capacity component with a same planar shape can be added, the frequency selective surface can be downsized.

It should be noted that a thickness of the dielectric film 103 (FIG. 8(b)) is a thickness in a range where a capacity component that is added by a second conductive pattern or a third conductive pattern can be handled with a lumped constant. For example, when a pitch at which the resonator k_{xy} is periodically arranged on the dielectric substrate 101 is 10 mm, intervals between conductive patterns may be set to around 0.125 mm. Accordingly, propagation of electromagnetic waves resembling a transmission line in a thickness direction can be ignored and the frequency selective surfaces 200 and 300 can be readily designed.

As described above, with the frequency selective surface 100 according to the present embodiment, three resonance frequencies centered on a cutoff frequency f_{Sb} and including a low frequency-side transmission frequency f_{Lb} and a high frequency-side transmission frequency f_{Hb} are obtained. Each resonance frequency is determined by respectively corresponding parameters. Therefore, a frequency selective surface of which an operating frequency and a bandwidth thereof can be readily adjusted can be provided.

In addition, the frequency selective surface 200 includes a sub-resonator corresponding to the main resonator k_{xy}. According to a conductive pattern constituting the sub-resonator, an operating frequency and a bandwidth thereof can be adjusted. The bandwidth of the cutoff frequency can be readily adjusted by adjusting the sub-resonator without changing the main resonator k_{xy}.

In addition, the frequency selective surface 300 includes sub-resonators respectively corresponding to the low frequency-side bandpass resonator k_{Lb} and the high frequency-side bandpass resonator k_{Hb}. According to conductive patterns that constitute respectively corresponding sub-resonators, an operating frequency and a bandwidth thereof can be adjusted. Since the resonance frequency of the sub-resonators can be individually adjusted, an operating frequency and a bandwidth thereof can be readily adjusted.

It should be noted that the sub-resonator corresponding to the main resonator k_{xy} and sub-resonators respectively corresponding to the low frequency-side bandpass resonator k_{Lb} and the high frequency-side bandpass resonator k_{Hb} can also be mounted on a same frequency selective surface. In addition, the planar shapes of the frequency selective surfaces respectively shown in FIGS. 1, 7, and 11 are merely examples and the shape of a conductive pattern is not limited thereto. For example, a width of the conductive pattern that is joined to an electrode plate part of another adjacent resonator may be narrower than the illustrated width or wider than the illustrated width. In this manner, it is obvious that the present invention includes various embodiments and the like not described in the present specification. Therefore, the technical scope of the present invention is to be determined solely by matters which are used to specify the invention in the scope of the following claims and which are appropriate in light of the above teachings.

### REFERENCE SIGNS LIST

100, 200, 300 Frequency selective surface
103 Dielectric film
10 Lateral pattern (conductor wire part)
20 Longitudinal pattern (conductor wire part)
12, 12a, 12b Electrode plate part
13, 13a, 13b Notched part
14 Conductive pattern (conductive pattern that is joined to an electrode plate part of another adjacent resonator)
k_{xy} Resonator (main resonator)
d Interval with electrode plate part of another adjacent resonator
D Interval across diagonal line of tip portion of electrode plate part
l Length of lateral pattern and longitudinal pattern
w Width of lateral pattern and longitudinal pattern
h Length of electrode plate part 12 in x direction (height of trapezoid)
cₓ Width of notched part
c_{y} Depth of notched part
w₂ Width of conductive pattern that bridges inside of notched part
g Width of interval of tip portion of electrode plate part F_{kLb1}, F_{kLb2}, F_{kHb1} Second conductive pattern

1. A frequency selective surface structured such that resonators formed by conductive patterns with a same shape are periodically arranged on a dielectric substrate, wherein a resonator comprises:
a conductor wire part comprising a lateral pattern and a longitudinal pattern, the lateral pattern and the longitudinal pattern form a cross above the dielectric substrate; and
an electrode plate part, extended in directions in which the lateral pattern and the longitudinal pattern are orthogonal to each other, respective both end parts of the lateral pattern and the longitudinal pattern extended by a prescribed length,
the electrode plate part is shaped such that an extended tip portion opposes a tip portion extended from another direction at an interval above a diagonal line, and
the electrode plate part is shaped such that a central portion opposing an electrode plate part of another adjacent resonator is notched in a notched portion in a width of the lateral pattern,
the electrode plate part is joined with the electrode plate part of the other adjacent resonator by extending from a center of the notched portion in a width that is narrower than the width of the lateral pattern and in a length that is shorter than the prescribed length, and
the interval of the tip portion is wider than an interval with the electrode plate part of the other adjacent resonator.

2. The frequency selective surface according to claim 1, comprising a second conductive pattern that is arranged on the conductive pattern so as to sandwich a dielectric film, wherein a planar shape of the second conductive pattern is a shape which covers a same portion of adjacent resonators and a shape which covers a space between the electrode plate parts of a same resonator.

3. The frequency selective surface according to claim 2, comprising a third conductive pattern that is arranged on the second conductive pattern so as to sandwich the dielectric film, wherein a planar shape of the third conductive pattern is a same shape as the second conductive pattern or a different shape from the second conductive pattern.

4. The frequency selective surface according to claim 3, wherein a thickness of the dielectric film is a thickness in a range where a capacity component that is added by a second conductive pattern or a third conductive pattern is handled with a lumped constant.
